(19) United States
(12) Patent Application Publication
(10) Pub. No.: US 2020/0345008 A1
(43) Pub. Date: Nov. 5, 2020

(54) Increased grape yields with brassinosteroid application

(71) Applicant: Naga Bhushan Mandava, Potoma, MD (US)

(72) Inventor: Naga Bhushan Mandava, Potoma, MD (US)

(21) Appl. No.: 16/865,500

(22) Filed: May 4, 2020

Related U.S. Application Data
(60) Provisional application No. 62/843,106, filed on May 3, 2019.

(51) Int. Cl. A01N 43/22; A01N 43/12

(52) U.S. Cl. CPC A01N 43/22; A01N 43/12

(57) ABSTRACT

We disclose methods to achieve improved characteristic traits of grapes such as decreased maturation time, increased fruit firmness, soluble solid content, as well as other quality parameters such as increased fruit set by foliar application of the plant growth regulator homobrassinolide.

### FIELD OF THE INVENTION

The subject matter of this application pertains to a method for using Plant Growth Regulators (PGRs) to improve certain desired characteristics of grapes including maturation time, fruit firmness, soluble solid content, increased fruit set, and increased fruit size. More precisely, the subject matter of this application pertains to methods of improving certain desired characteristics of grapes including maturation time, fruit firmness, soluble solid content, increased fruit set, and increased fruit size with the use of homobrassinolide (CAS #80483-89-2).

### BACKGROUND

Grapes have been domesticated since perhaps as early at 6,000 BC. They can be enjoyed freshly picked from the vine or made into jams, jellies, or extracts. They can be processed into grape seed oil or dried to become raisins. Grape skin is an attractive substrate for wild yeasts which leads to to the grape's highest calling: wine.

According to the 2016 report “Table and Dried Grapes,” published by Food and Agriculture Organization of the United Nations and the International Organization of Vine and Wine (http://www.fao.org/3/a-i7042e.pdf) grapes are one of the world largest fruit crops with approximately 75 million tonnes (75 billion kilograms) produced each year worldwide.

Brassinosteroids (“BRs”) are important steroid plant growth regulating hormones.

Brassinosteroids are found throughout the plant kingdom and have unique growth promoting activity when applied exogenously to plants (Mandava, N. B. Plant growth promoting brassinosteroids. Annual Review of Plant Physiology and Plant Molecular Biology 1988, 39; 23-52). Brassinolide, the first identified brassinosteroid, was first isolated in 1979 from rape (Brassica napus L.) pollen, where it is present in quantities up to 200 parts per billion.

Since the discovery of the chemical structure of brassinolide (“BL” CAS #74174-44-0), it has been synthesized and analogues have been developed, often from readily available plant sterols. Among the brassinosteroids shown to have similar biological activity as BL are epibrassinolide (“epi BL” CAS #78821-42-8), homobrassinolide (“HBR” CAS #80483-89-2, FIG. 1), castasterone (“CS” CAS #80736-41-0), 28-homocastasterone (“HCS” CAS #83509-42-6). Castasterone and 28-homocastasterone are converted to BL and HBR, respectively, in vivo.

BRs are reported to increase yields and improve stress resistance of several crop plants (Cutler, H. G., et. al., Brassinosteroids: chemistry bioactivity, and applications. ACS symposium Series 474. Washington D.C., 1991; American Chemical Society). Brassinosteroids are known to enhance both cell division and cell elongation; elicit profound physiological responses at concentrations as low as 10⁻²³ M; interact synergistically with other PGRs; elicit responses mostly in meristematic tissues; and control the growth and development of crops in a tissue specific and organ specific manner. Treatments with BRs are effective ways of increasing yield of many crops even in cases of drought, extreme temperatures, and improper soil salinity. For example, in almond trees, BRs have been shown to counteract the slowed pollen tube growth rate caused by lower temperatures (Bernard, D. and Socias, R. I Company. Characterization of Some Self-compatible Almonds. II. Flower Phenology and Morphology. HortScience, 1995, 30(2): 321-324).

There are grape fruit quality factors that are important to farmers and consumers alike. Fruit color effects aesthetic appeal and darker color develops with sugar production causing the fruit to be sweeter as the fruit matures (D. K. Salunkhe, S. S. Kadam “Handbook of fruit science and technology” pg 13 CRC Press, 1995) Color can be determined visually or measured by red pigment anthocyanin levels. Sugar levels in grapes can be quantified by levels of soluble solids in which higher soluble solid levels indicates higher sugar content. High fruit firmness can reduce the risk of damage from handling during the harvest and processing. Fruit firmness rapidly declines after harvesting (Özkaya O. Dündar Ö. Küden A. “Effect of preharvest gibberellic acid treatments on post-harvest quality of sweet cherry” J. Food Agr. Environ. 4189191, 2006), therefore, harvesting at peak firmness gives farmers more time to reach farther markets while ensuring desirable fruit firmness to customers. Firmness can be assessed both by firmness of the fruit body and the stem force removal.

Finally, weight and size of grapes are also important properties in grape growing. Heavier grapes means more yield to the farmer and larger grapes have higher appeal to consumers. It is essential when harvesting grapes to pick them when matured, handle delicately, and store properly in order to maintain the quality of grapes. In addition to harvesting and storage techniques, the plant growth regulator (PGR) gibberellic acid (GA3) is typically applied to grapes to increase shelf life, because GA3 will increase firmness of grapes (Lenahan et al., 2006), however this increased firmness is a function of juvenility effect which is associated with inhibited color development. As grapes are typically not harvested before reaching the color standard for that variety, GA3 treatment by itself may actually increase the time to harvest.

Methods of increasing desired characteristics in grapes including fruit set, berry weight, firmness, and color can result in a higher return on investment for growers.

### SUMMARY

The field of this invention pertains to a method of using the plant growth regulator HBR to improve characteristic traits of grapes including: maturation time, fruit firmness, soluble solid content and other quality parameters such as increased fruit set and size.

### BRIEF DESCRIPTION OF THE FIGURES

FIG. 1 is the chemical structure of homobrassinolide.

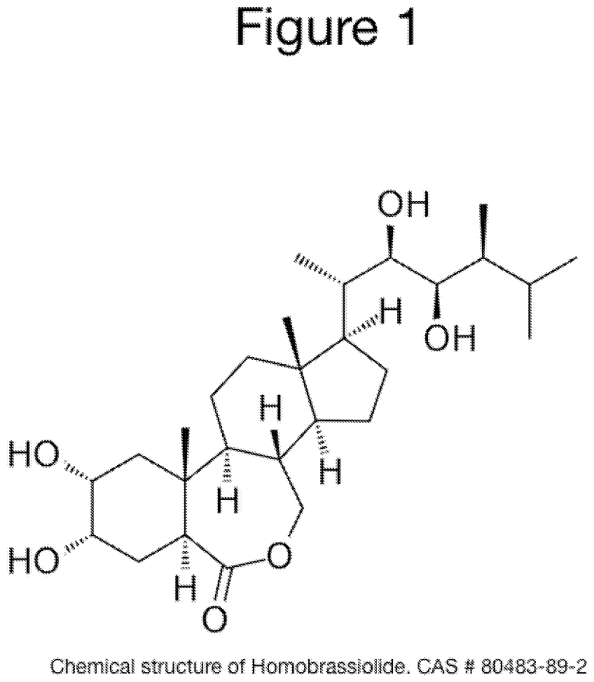

FIG. 2 is a summary table of results of Experiment 1.

FIG. 3 is a summary table of results of Experiment 2.

FIG. 4 is a summary table of results of Experiment 3.

### DETAILED DESCRIPTION OF THE SUBJECT MATTER

The following description and referenced figures illustrate embodiments of the subject matter of this application. They are not intended to limit the scope of the claims. Those familiar with the art may recognize that other embodiments of the disclosed method are possible. For example, analogues of the applied brassinosteroid having the same or substantially similar growth-promoting properties should be considered equivalent to the claimed chemical. All such alternative embodiments should be considered within the scope of the application's claims.

Experiment 1.

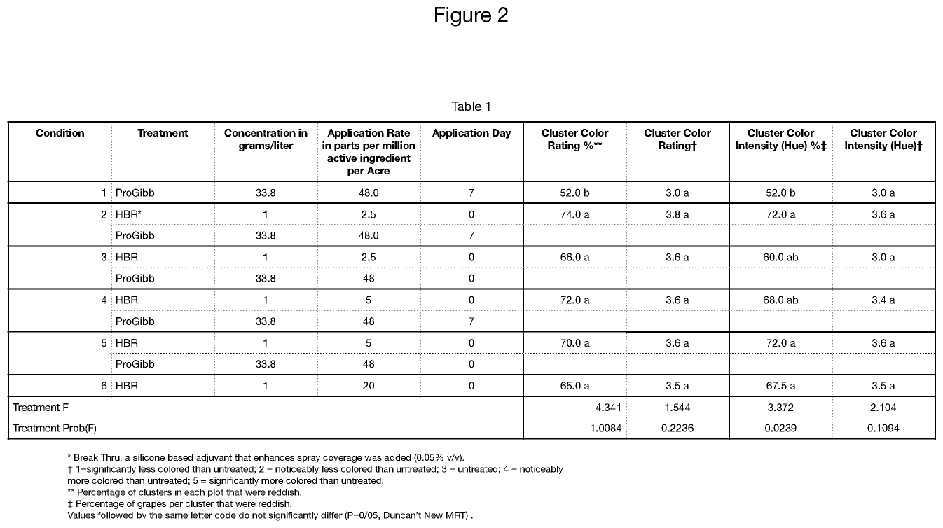

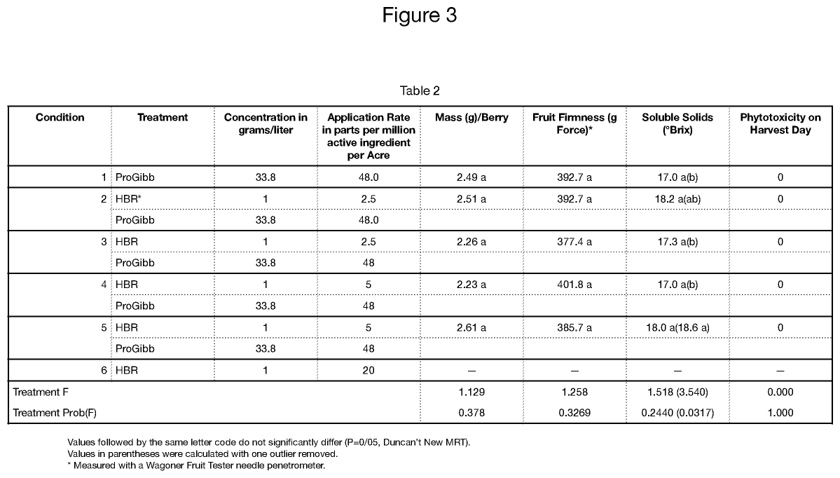

Treatment (HBR) was twice applied to grapes of the variety Flame Seedless. Treatments consisted of either HBR or ProGibb (ProGibb 4%, a plant growth regulator commonly used on table grapes for berry thinning and/or increasing berry size). At the first application (Day 0) the grapes were approximately 3 mm in diameter. The second application was seven days later (Day 7) when the grapes were approximately 6 mm in diameter. The HBR was applied with a backpack mist blower at a rate if 100 gallons per acre. Grapes were evaluated for Cluster Color Rating and Cluster Color Intensity (Hue) on about Day 65 by comparing test subjects with the control of condition 1. The data from this experiment is summarized in Table 1 (FIG. 2). The same data set was analyzed for berry weight, berry firmness, Brix units, and phytotoxicity. That data is summarized in Table 2 (FIG. 3).

Application of HBR on Day 0 at a rate of 2.5 ppm/aiA increased the percentage of clusters per plot that were noticeably reddish, and resulted in a more intense color per reddish cluster than control. Within each identified reddish cluster, treatment with HBR increased the percentage of reddish grapes and increased the color intensity as compared to control. Table 1 (FIG. 2).

Application with HBR on Day 0 tended to increase the degrees Brix of the grapes with no observed phytotoxicity.

Experiment 2.

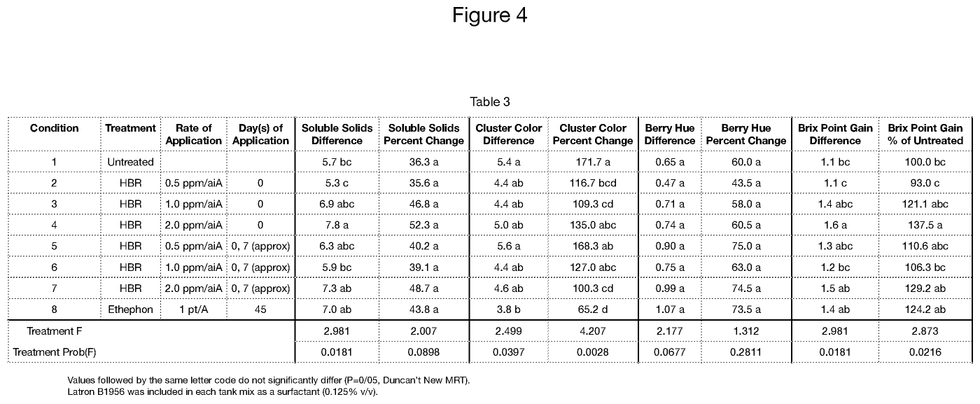

Homobrassinolide (HBR) was applied on grapes (var. Scarlet Royal) at late bloom (Day 0), or at late bloom (Day 0) and again at approximately 1 week after berry set (Day 7). Grapes were approximately 3 mm in diameter at Day 0 and 6 mm in diameter at Day 7. HBR was applied at rates of 0.5 ppm/aiA, 1.0 ppm/aiA, and 2.0 ppm/aiA. Spray applications were made using a backpack mistblower to simulate commercial airblast applications at 100 gpa. Controls were an untreated group, and a group that received the standard treatment with Ethephon approximately two weeks after color break (Day 45). Evaluations were made at Days 54, 66, 75, 82, 90, and 97. All treated groups also received Latron B1956 which was added to each tank mix as a surfactant (0.125% v/v). Soluble solids, cluster color, and berry hue were enhanced by HBR and the ethephon standard treatment. Those grapes receiving two applications of HBR and those grapes receiving single applications of 1.0 ppm/aiA and 2.0 ppm/aiA of HBR demonstrated increased soluble solids and Brix degrees and were judged to have increased percentages of clusters of color and greater hue than those graphs receiving a single application of 0.5 ppm/aiA HBR. A positive rate response was demonstrated between the single spray timing treatments and the untreated check. The most efficacious treatment was the double spray of 2 ppm ai HBR compared to the ethephon standard treatment. Both consistently showed ripening responses that were significantly more effective than the untreated check. No crop injury was observed. Results are illustrated in Table 3 (FIG. 4).

We claim:

1. A method of decreasing the maturation time of grape varieties as determined by hue by applying homobrassinolide.

2. The method of claim 1 in which homobrassinolide is applied at a rate of between approximately 0.5 and 5.0 parts per million active ingredient per acre.

3. The method of claim 1 in which said grapes are selected from the set consisting of Flame Seedless and Scarlet Royal.

4. The method of claim 1 in which said homobrassinolide is applied at a rate of between approximately 2.5 and 5.0 parts per million active ingredient per acre.

5. The method of claim 1 in which said homobrassinolide is applied when said grapes are approximately 3 mm in diameter.

6. The method of claim 1 further comprising the step of applying ProGibb approximately seven days after the application of homobrassinolide.

7. The method of claim 1 further comprising the step of applying ProGibb approximately seven days after the application of homobrassinolide at a rate of 48.0 parts per million active ingredient per acre.

8. A method of decreasing the maturation time of grapes as determined by hue by spraying a first application of homobrassinolide at a rate of between approximately 0.5 and 2 parts per million active ingredient per acre.

9. The method of claim 8 in which said grapes are selected from the set consisting of Flame Seedless and Scarlet Royal.

10. The method of claim 8 in which said homobrassinolide is applied when grapes are approximately 3 mm in diameter.

11. The method of claim 8 further comprising a second application of homobrassinolide and in which said first application of homobrassinolide is sprayed when grapes are approximately 3 mm in diameter and said second application of homobrassinolide is sprayed approximately seven days after the first application.
